(19) United States
(12) Patent Application Publication
(10) Pub. No.: US 2025/0224539 A1
(43) Pub. Date: Jul. 10, 2025

(54) COMPUTER IMPLEMENTED METHOD FOR AN ACTIVITY BASED WEATHER FORECASTING SYSTEM

(71) Applicant: Kenneth R. Fenton, JR., Boulder, CO (US)

(72) Inventor: Kenneth R. Fenton, JR., Boulder, CO (US)

(21) Appl. No.: 18/405,505

(22) Filed: Jan. 5, 2024

(51) Int. Cl. G01W 1/00

(52) U.S. Cl. CPC G01W 1/00; G01W 2203/00

(57) ABSTRACT

According to aspects of the present invention, a computer-implemented method and system for an activity-based weather forecasting service is provided. The invention introduces an innovative, user-centric approach to weather forecasting, tailored to individual activities and preferences. This system bridges the gap in traditional weather forecasting by offering a personalized interface, which includes a color-coded advisory system akin to traffic signals, to signal the suitability of weather conditions for various user-defined activities enabling decision support to the user. Graphical user interfaces allow users to choose from pre-set activities, create custom activities, and set personal weather thresholds for these activities. The system employs at least one processor to coordinate these interfaces and backend processes, dynamically adjusting forecasts to correct for any biases and cater to the user-defined parameters. This invention transforms weather forecasting into a dynamic, personalized tool, providing actionable weather guidance and decision support tailored to individual activities.

### BACKGROUND

Traditional weather forecasting methods often lack the specificity and customization necessary for individual activity planning. Commonly available weather services provide general forecasts which are typically focused on weather information rather than specific user needs and decision support. These general forecasts do not properly address the specific requirements of individuals planning outdoor and weather-sensitive activities. This gap in weather forecasting services presents a unique opportunity for innovation within the realm of personalized weather forecasting and activity-based weather decision support.

Existing weather forecasting systems, while comprehensive in their scope, primarily target broad audiences and lack the granularity needed for specific activities. Current systems do not offer the flexibility to integrate personal activity profiles with weather data to generate custom forecasts. This disconnect between user-specific activities and weather predictions highlights the need for a new approach.

The limitations of many current weather forecasting systems are further amplified by their reliance on generic and often regionally-biased data sources. These sources may not accurately reflect variations in the weather that are critical for specific activities. The combination of outdated interfaces and potentially biased weather forecasting data underscores an important gap in the current landscape of weather forecasting software which needs to be addressed.

### SUMMARY

In view of the circumstances outlined above, aspects of the present invention disclose systems and methods for implementing software for activity-based weather forecasting and decision support. This invention addresses the limitations of traditional weather forecasting software by introducing a novel combination of features catered to activity-based users.

According to an aspect of the present invention, there is provided a computer-implemented method for the implementation of an activity-based weather forecasting service, comprising: displaying a user interface for the user to input information comprising personal information, activity-based information, and weather-related information; storing a variety of user activity preferences and weather thresholds as data objects in a database; displaying graphical user interfaces at a computer terminal enabling the user abilities comprising, viewing color-coded activity based forecasts, selecting from pre-set activities with pre-set weather thresholds, creating custom activities, and setting personal weather thresholds for these custom activities; at least one processor aligned to coordinate these interfaces and the backend processes involved; at least one processor aligned to dynamically adjust the forecast interfaces as well as send real time notifications to the user based on a combination of user selected thresholds and real-time weather data; at least one processor aligned to diversely source and dynamically remove any potential biases due to homogenic data sourcing, or resolution based discrepancies from weather data.

According to another aspect of the present invention, there is provided a system, comprising: at least one I/O device(s) associated with and communicatively connected to a terminal, arranged to store data and execute processes related to activity-based weather forecasting; a server processing system and client processing interfaces, communicatively connected and arranged to facilitate the customization of weather forecasts based on user selected activity preferences; at least one processor arranged to apply color-coded weather advisories, provide real-time updates/notifications to users, customize forecasts based on individual activity thresholds, and remove any potential biases due to homogenic data sourcing or resolution based discrepancies.

Further, the invention includes enhanced subscription features that allow for advanced customization of weather-related parameters, offering granular levels of detail in forecasts comprising secondary weather advisories and user-defined interpretations of weather data, adjustment of color-coded weather advisories, enhanced confidence levels in forecasts, and the inclusion of detailed weather phenomena information, thereby significantly enriching the user experience.

### BRIEF DESCRIPTION OF THE DRAWINGS

FIG. 1 depicts the user flow for the user input leading to activity-based weather forecasts.

FIG. 2 depicts the process flow for retrieving the forecast, retrieving localized bias corrected weather data, and color-coding the forecast based on the thresholds for the user selected activity.

FIG. 3 depicts the back-end processes to retrieve weather data and remove potential biases or discrepancies.

FIG. 4 shows the user flow to create custom activities and edit the thresholds on new and existing activities.

### DETAILED DESCRIPTION OF THE DRAWINGS

Embodiments illustrative of the present invention are described with reference to the attached diagram, which outlines the operational flow of an activity-based weather forecasting service from user input to the personalization of weather information and decision support.

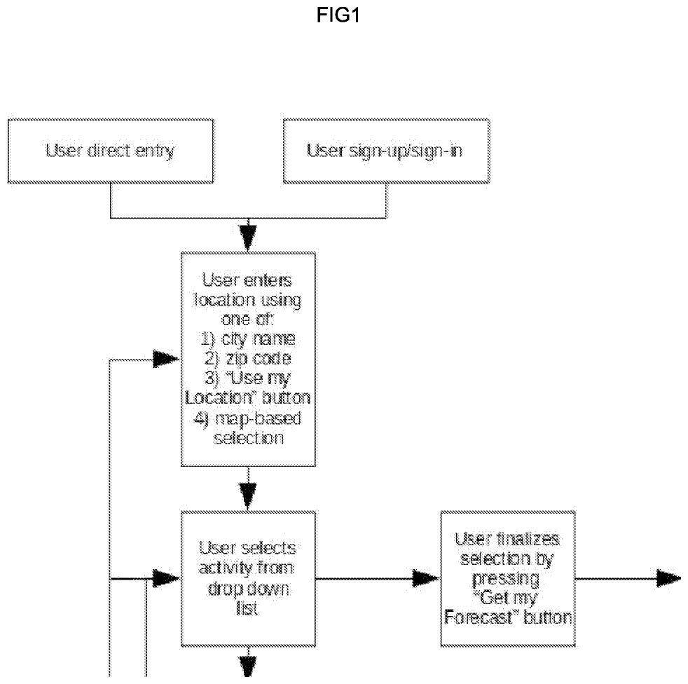

### FIG. 1—User Input to Location and Activity Selection

FIG. 1 depicts the user entry points where the user has the option to create an account or directly interact with the website. The user is then guided through a process designed to tailor the weather forecasting interface to the user's activities. This interface, developed using modern web technologies such as HTML5, CSS, JavaScript, and React frameworks, provides a seamless experience for users to input their location and desired activity information.

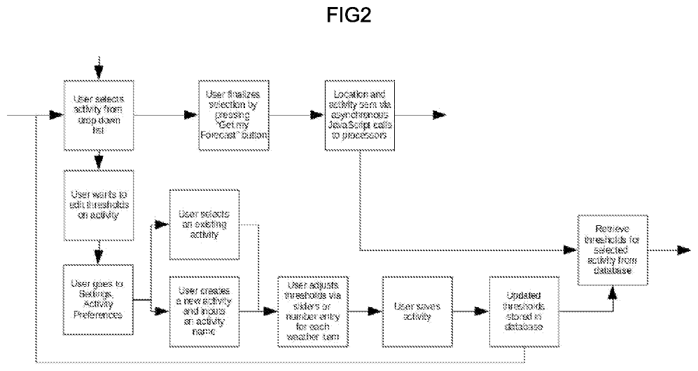

### FIG. 2—Back End Processing to Generate the Forecast

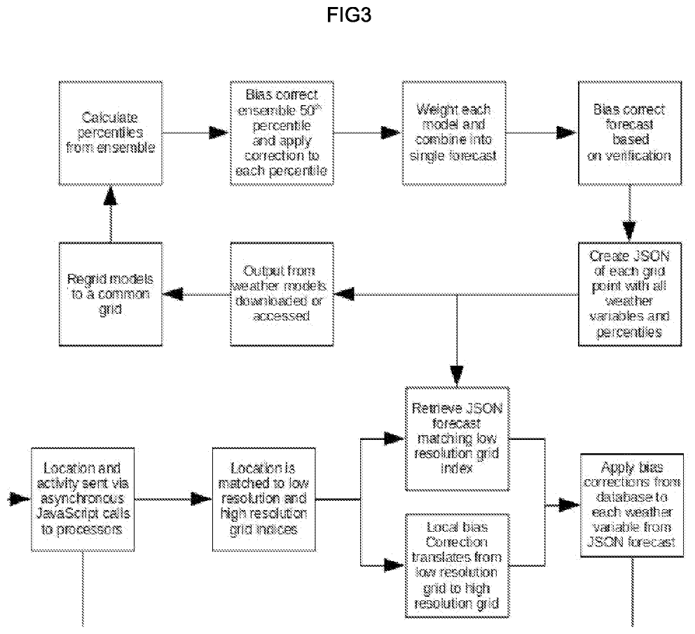

FIG. 3 shows the back-end process that creates a forecast utilized by the front end display system. The process includes fetching forecasts via asynchronous JavaScript calls to retrieve datasets in JSON format. The weather model data is downloaded from various government sources and/or cloud providers. The data is filtered based on associated verification status (meta data for from an audit which verifies the accuracy of the model producing the data). All models that have passed the verification are then normalized to a common 16-kilometer grid via ArcGIS for geospatial data processing. Using Python libraries comprising scikit-learn, statsmodels, numpy, xarray and pandas; models are aggregated into ensembles and the value of each weather feature at the prescribed percentile is saved, the 50^{th} percentile of each ensemble is bias corrected and the value of that bias correction is applied to all other percentiles (resulting in a smoothly adjusted envelope of forecast outcomes), the various ensembles and other weather models are combined according to assigned weights, and the value of each weather feature at each prescribed percentile and hour, is saved into a JSON file for each model grid location and/or city location. Finally using the same array of Python libraries a localized bias correction algorithm is applied where features from the high resolution localized forecast (2.5 kilometer grid) are integrated into a low resolution macro forecast (16 kilometer grid). By combining the two forecasts, features of both localized dynamic weather trends and greater macro weather trends can be integrated for a more comprehensive forecast. After all backend processing is complete the data is sent to the front end for user interpretation.

### FIG. 3—User Ability to Create and Customize Activities

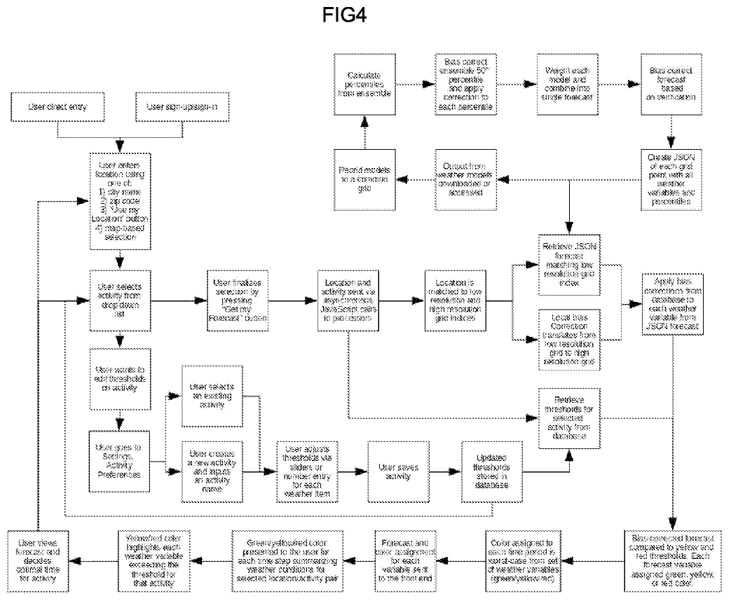

FIG. 4 shows the process for a user to create and customize activities. This process is enabled by modern web technologies such as HTML5, CSS, JavaScript, and React frameworks, it allows the user full control over when weather conditions will be classified as green, yellow, or red. The user has the ability to create new activities and then customize the thresholds for any new or existing activity. New activities and changes to existing activities are saved in a database that is accessed by the API when location and activity combinations are requested.

The described system and processes highlight the present invention's commitment to delivering a highly personalized and dynamic weather forecasting service, which goes beyond traditional methods by offering a user-centric interface for activity planning based on customized weather thresholds and advisories.

### FIG. 4—Front End Data Interpretation and User Interface

FIG. 2 shows the process for returning a color-coded forecast to the user based on the user's location and activity selections. The bias corrected forecast and weather threshold for the selected activity are retrieved and then compared. If the bias corrected forecast features exceed the red thresholds, then the associated weather feature is assigned a red color. If the bias corrected forecast features exceed the yellow thresholds but don't exceed the red thresholds, then the associated weather feature is assigned a yellow color. If the bias corrected forecast exceeds neither the yellow nor red thresholds, then that weather feature is assigned a green color. This processing is completed for all time steps and all associated weather features. A color is assigned to each time step in the following manner; red indicates poor conditions, yellow indicates sub optimal conditions and green indicates optimal conditions. The color for each feature and its corresponding time period is presented to the user. The resulting color coded forecast summarizes the suitability of said activity for the associated time and location.

What is claimed is:

1. A computer-implemented method for the implementation of an activity-based weather forecasting service, comprising: displaying a user interface for the user to input information comprising personal information, activity-based information, and weather-related information; storing a variety of user activity preferences and weather thresholds as data objects in a database; displaying graphical user interfaces at a computer terminal enabling the user abilities comprising, viewing color-coded activity based forecasts, selecting from pre-set activities with pre-set weather thresholds, creating custom activities, and setting personal weather thresholds for these custom activities; at least one processor aligned to coordinate these interfaces and the back end processes involved; at least one processor aligned to dynamically adjust the forecast interfaces as well as send real time notifications to the user based on a combination of user selected thresholds and real-time weather data; at least one processor aligned to diversely source and dynamically remove any potential source based or resolution based biases from weather data.

2. The method of claim 1, wherein the user interface includes a color-coded display system that indicates weather suitability for user-selected activities, with colors representing different levels of suitability.

3. The method of claim 1, wherein the weather forecasting service includes a subscription-based model that provides users with enhanced features, such as the ability to create custom activities and set more granular weather thresholds.

4. The method of claim 1, further including a feature that allows users to receive notifications about the forecast weather conditions relevant to their selected activities at predetermined times.

5. The method of claim 3, wherein the subscription-based model offers users the ability to receive advanced weather information, such as thunderstorm probabilities, heat index, wind chill, humidity, dewpoint, and rain/snow amounts by hour.

6. The method of claim 1, further comprising a user-customizable alert system where users can set the conditions under which they will receive alerts, based on their personal weather thresholds for selected activities.

7. The method of claim 1, wherein the user interface is configured to provide an expanded view of weather conditions upon user interaction, including details such as temperature, wind, cloud cover, and precipitation for each activity.

8. The method of claim 1, wherein the database is hosted on a cloud-based platform with high availability and scalability to handle a large number of user requests simultaneously.

9. The method of claim 1, further comprising integrating the weather forecasting service with external calendar applications to automatically suggest the best times for activities based on the weather forecast and user's schedule.

10. The method of claim 1, to apply multiple phases of bias correction to weather forecasts comprising, data model authentication, 50^{th} percentile ensemble correction, and location specific weather feature correction via systematic resolution based algorithms.

11. A system, comprising: at least one I/O device(s) associated with and communicatively connected to a terminal, arranged to store data and execute processes related to activity-based weather forecasting; a server processing system and client processing interfaces, communicatively connected and arranged to facilitate the customization of weather forecasts based on user selected activity preferences; at least one processor arranged to apply color-coded weather advisories, provide real-time updates/notifications to users, customize forecasts based on individual activity thresholds, and remove any potential biases due to resolution based discrepancies or homogenic data sourcing.
